(19) United States
(12) Patent Application Publication
(10) Pub. No.: US 2022/0401996 A1
(43) Pub. Date: Dec. 22, 2022

(54) A Conveyor Sorting Device

(71) Applicant: Interroll Holding AG, Sant' Antonino (CH)

(72) Inventors: Xavier Frangeul, Hückelhoven (DE); Antoine Loizeau, Hückelhoven (DE)

(21) Appl. No.: 17/638,187

(22) PCT Filed: Sep. 7, 2020
(86) PCT No.: PCT/EP2020/074966

§ 371 Date: Feb. 25, 2022

(30) Foreign Application Priority Data
Sep. 11, 2019 (EP) 19196729.8

(51) Int. Cl. B07C 5/36

(52) U.S. Cl. CPC B07C 5/362; B07C 2501/0063

(57) ABSTRACT

A conveyor sorting device that comprises an input port for receiving objects of different object categories, and a sorting device with a handling unit constituting a holding device for receiving and holding an object input via the input port and a transfer device for transferring said object to a primary storage unit. Said primary storage unit comprises a plurality of n primary storage positions each of said primary storage positions being associated to a carrier for one specific object category. A secondary storage unit comprises a plurality of m secondary storage positions each of said secondary storage positions being associated to a carrier for one specific object category. A conveyor device has been adapted to convey a carrier from said primary storage unit to said secondary storage unit and to convey a carrier from said secondary storage unit to said primary storage unit.

### CROSS REFERENCE TO RELATED APPLICATIONS

This application is the U.S. national stage of International Application No. PCT/EP2020/074966, filed on 2020 Sep. 7. The international application claims the priority of EP 19196729.8 filed on 2019 Sep. 11; all applications are incorporated by reference herein in their entirety.

### BACKGROUND

The invention is directed to a conveyor sorting device. A further aspect of the invention is a method for sorting objects.

A conveyor sorting device and a method for conveying objects is usually required in conveying situation, wherein a plurality of objects of different categories are input into an input port and are to be distributed to different carriers according to their category. The result of such sorting action is the filling up of a plurality of carriers with said objects, wherein each carrier carries objects of a single category or of predetermined categories only.

Whilst sorting out objects of two, three or even four different categories may be conducted in sorting devices directly dividing up the objects to two, three or four carriers placed in said sorting device directly. The sorting of objects with more than four categories like e.g. more than 20, more than 50 or more than 100 categories cannot be accomplished efficiently with such direct sorting strategy when further considering a limited space available for such sorting device, since it can be expected to be inefficient with regard to spatial considerations to provide such high number of carriers available for taking up the objects of the plurality of categories.

It is known to iteratively conduct such a sorting process for high numbers of categories in such a way that in a first sorting step, a plurality of categories is commonly sorted on one carrier and in this first sorting step two, three or four objects are thus stored on a single carrier of a number of carriers. In a second iteration of the sorting step then, a single carrier out of said first sorting step is sorted again and by this, at a final end, a sorting out of objects on carriers, carrying a single category only, can be achieved. Whilst such sorting strategy may realize an efficient spatial demand, the time for conducting such sorting action according to this sorting method is rather lengthy and thus not efficient.

US 2018/0273297 A1 discloses an automated programmable motion control system, e.g., robotic, sortation and other processing systems, and relates in particular to programmable motion control systems intended for use in environments requiring that a variety of objects (e.g., articles, packages, consumer products etc.) be processed and moved to a number of processing destinations.

### SUMMARY

A conveyor sorting device, comprising:

an input port (10) for receiving objects of different object categories,

a sorting device (20) with a handling unit comprising a holding device (21) for receiving and holding an object input via the input port (10) and a transfer device for transferring said object to a primary storage unit (30),

wherein

said primary storage unit (30) comprises a plurality of n primary storage positions (31, 32, 33, 34) each of said primary storage positions (31, 32, 33, 34) being associated to a carrier (340) for one specific object category,

a secondary storage unit (50) comprising a plurality of m secondary storage positions each of said secondary storage positions being associated to a carrier (340) for one specific object category,

a conveyor device adapted to convey a carrier (340) from said primary storage unit (30) (30) to said secondary storage unit (50) and to convey a carrier (340) from said secondary storage unit (50) to said primary storage unit (30),

a control unit adapted

to receive information identifying an input category of an input object transferred to the sorting device (20) via the input port (10),

to compare said input category with the said categories associated with said primary storage positions (31, 32, 33, 34),

if any of said primary storage positions (31, 32, 33, 34) is associated to said input category:

to control said handling unit for receiving said input object and to transfer said input object to a primary storage position associated to said input category, if none of said primary storage positions (31, 32, 33, 34) is associated to said input category

to control said conveyor device to convey one of said carriers (340) from one of said primary storage positions (31, 32, 33, 34) to said secondary storage unit (50),

to control said secondary storage unit (50) to provide a carrier (340) stored in said secondary storage unit (50) and associated with said input category to said conveyor device,

to control said conveyor device to convey said carrier (340) provided by said secondary storage unit (50) to said one of said primary storage positions (31, 32, 33, 34) wherefrom a carrier (340) had been transferred to said secondary storage unit (50), and

to control said handling unit for receiving said input object and to transfer said input object to the primary storage position comprising said carrier (340) which had been transferred from said secondary storage unit (50) and which is associated to said input category.

### DETAILED DESCRIPTION

It is an object of the invention to provide a sorting device and a sorting method, wherein efficient sorting of objects of different categories is achieved on both, a low number of categories to be sorted and a high number of categories to be sorted.

This object is achieved by a sorting device comprising an input port for receiving objects of different object categories, a sorting device with a handling unit comprising a holding device for receiving and holding an object input via the input port and a transfer device for transferring said object to a primary storage unit wherein said primary storage unit comprises a plurality of m primary storage positions each of said primary storage positions being associated to a carrier for one specific object category, a secondary storage unit comprising a plurality of n secondary storage positions each of said secondary storage positions being associated to a carrier for one specific object category, a conveyor device, adapted to convey a carrier from said primary storage unit to said secondary storage unit and to convey a carrier from said secondary storage unit to said primary storage unit, a control unit adapted to receive information identifying an input category of an input object transferred to the sorting device via the input port, to compare said input category with the said categories associated with said primary storage positions, if any of said primary storage positions is associated to said input category to control said handling unit for receiving said input object and to transfer said input object to a primary storage position associated to said input category, if none of said primary storage positions is associated to said input category to control said conveyor device to convey one of said carriers from one of said primary storage positions to said secondary storage unit, to control said secondary storage unit to provide a carrier stored in said secondary storage unit and associated with said input category to said conveyor line, to control said conveyor device to convey said carrier provided by said secondary storage unit to said one of said primary storage positions wherefrom a carrier had been transferred to said secondary storage unit, and to control said handling unit for receiving said input object and to transfer said input object to the primary storage position comprising said carrier which had been transferred from said secondary storage unit and which is associated to said input category.

The sorting device according to the invention, is based on a sorting principle using a primary and a secondary storage unit. The primary storage unit comprises a discrete, small number of primary storage positions, wherein a carrier can be placed in each of said primary storage positions to place objects of one single category in such primary storage position, e.g. on a carrier like a pallet placed in such primary storage position. In practical use, in such primary storage positions, objects of such categories should be placed which are mainly contained in the objects of different categories supplied to the sorting device. By this, an efficient direct sorting of objects is achieved in this discrete number of primary storage positions.

A category is in particular understood to be associated to a primary or a secondary storage position if a carrier like a pallet, which is associated to said category is positioned in said primary or secondary storage position. Thus, a category of a storage position may change if the carrier positioned in said storage position is exchanged with another carrier. Generally, a carrier may be associated to one category and this association shall not change.

The number of m primary storage positions, however, is limited and does not cover the total number of categories which can be sorted by the sorting device according to the invention. A secondary storage unit is provided comprising a plurality of n secondary storage positions. The number n of these secondary storage positions might be significantly larger than the number of m primary storage positions. The secondary storage positions are not directly accessible by the handling unit of the sorting device according to the invention. This shall be understood such that an object associated to a category to be placed on a carrier positioned in such secondary storage position cannot be placed directly by the handling unit on such carrier positioned in the secondary storage position.

In case that an object is input to the conveyor sorting device via the input port associated to a category to be placed on a carrier in such secondary storage position, the sorting device, according to the invention, conducts an exchange of a carrier between a primary storage position and said carrier in said secondary storage position. To this extent, a control unit controls a conveyor to convey a carrier out of a primary storage position into a free secondary storage position such that the primary storage position is free for receiving said carrier from said secondary storage position. The carrier positioned in the particular secondary storage position associated to the category of the object to be sorted is conveyed into the free primary storage position. The conveying of the carriers out of the primary into the secondary storage position and out of the particular secondary storage position into the free primary storage position can be conducted one after the other or simultaneously.

Hereafter, the object can be sorted to the primary storage position, occupied by the carrier conveyed out of the particular secondary storage position beforehand. It is understood that by such exchange of carriers, a new association of categories to the primary and secondary storage position wherefrom the carriers where exchanged takes place.

According to the invention, an efficient sorting of objects of a limited number of categories which are comprised as a majority in the objects' input to the sorting device can be achieved in a quick and efficient manner on a limited number of primary storage positions. However, the sorting device is capable of sorting objects of a plurality of categories with the number of categories being larger than the number of primary storage positions. By this, a limited space is occupied by the primary storage positions and the additional space required for the further categories is positioned in a secondary storage unit. The sorting device is capable of conducting an efficient exchange of carriers from said primary storage unit to said secondary storage unit and vice versa. By this, a time efficient sorting of objects of additional categories associated to carriers placed in a secondary storage position is achieved.

The conveyor device may preferably comprise a conveying line with a conveyor drive which is adapted to convey an object or preferably a carrier like a pallet from said primary storage unit to said secondary storage unit and vice versa. The distance between said primary storage unit and said secondary storage unit may preferably be above one meter, further preferably be above 2.5 meters such that a distant arrangement of the two storage units is possible with an efficient transfer of objects/carriers via the conveyor device.

According to a first preferred embodiment, said conveyor device comprises a first conveying track for conveying a carrier from said primary storage unit to said secondary storage unit and a second conveying track for conveying a carrier from said secondary storage unit to said primary storage unit. By using a first and a second conveying track, a simultaneous conveying of a carrier from the primary storage unit to the secondary storage unit and of a carrier from the secondary storage unit to the primary storage unit is possible. By this, the time required for exchanging a carrier in the primary storage unit by a carrier taken from the secondary storage unit can be reduced and the overall sorting time can be made more efficient. The two conveying tracks may be arranged side-by-side or one above the other. Each conveying track may have its own conveyor drive. Alternatively, both conveying tracks may be driven by a common conveyor drive mechanically coupled to both conveying tracks. The mechanically coupling of the conveyor drives and, in particular, of a single conveyor drive for both conveying tracks, may be accomplished via a clutch such that even when using a single conveyor drive, an individual control of each of the two conveying tracks is possible. The conveying tracks may e.g. be roller conveyor devices, wherein a plurality of rollers are installed in a rack to define a horizontal path, wherein the carriers are supported by the upper circumferential portions of the rollers and conveyed by a rolling motion of the rollers.

According to an alternative preferred embodiment, said conveyor device comprises a single conveying track for conveying a carrier from said primary storage unit to said secondary storage unit and vice versa. According to this preferred embodiment, a single conveying track is installed for the transport of carriers from the primary storage unit to the secondary storage unit and from the secondary storage unit to the primary storage unit. This embodiment may particularly rely on a conveying track, wherein a robot unit is used to transport a carrier from one storage unit to the other. In such case, the robot unit may efficiently be used in that a first carrier is conveyed from the primary storage unit to the secondary storage unit and, after this carrier has been delivered into the secondary storage unit, another carrier may be transported from the secondary storage unit to the primary storage unit on the way back of the robot unit to the primary storage unit. By this, the moving paths of the robot unit between the primary and the secondary storage unit are efficiently used and movements without a carrier moved by the robot unit are avoided.

In both alternatives, it is preferred that each of said conveying track comprises a rack element extending along a conveying direction, said rack element comprising a movable load carrying surface defined by a movable carrier device, a robot unit comprising a traction device for driving said robot unit along said rack element in said conveying direction and a driving device adapted to couple with said movable carrier device and to drive said movable carrier device, wherein said coupling of said driving device to said movable carrier device enables said driving device to move said movable load carrying surface.

According to this embodiment, a specific setup and functionality of the two conveying tracks of the first preferred embodiment or of the single conveying track of the second alternative preferred embodiment is employed to transfer the carriers from the primary storage unit to the secondary storage unit and vice versa. The conveying track basically comprises two elements, namely a rack element and a robot unit. The rack element serves as a guiding means for the robot unit and guides the robot unit from the primary to the secondary storage unit and/or from the secondary storage unit to the primary storage unit. The rack element further serves to support the carriers on their way from the primary to the secondary storage unit or from the secondary to the primary storage unit. For this purpose, a movable carrier device is comprised in the rack element. This movable carrier device defines a movable load carrying surface, upon which the carrier is supported.

The movable carrier device may e.g. comprise a plurality of rollers arranged in a side-by-side arrangement and being rotatably fixed in a frame extending along a conveying path defined by said rack element. The plurality of rollers may be arranged with their axes lying in a horizontal plane, thus defining an upper load carrying surface by the upper circumferential sections of the rollers. The rollers may be idle rollers, i.e. none of the rollers comprises a drive like e.g. is driven by a drive unit inside the roller body of the roller.

Instead of such roller track configured to define the movable carrier device, a belt extending along the rack element could be employed with the belt defining with its upper surface the load carrying surface. Such belt device may as well be configured as an idle belt configuration, i.e. without a drum motor or the like included in the belt configuration to drive the belt into a conveying movement.

As a second component, the conveying track comprises a robot unit. Said robot unit is adapted to drive along said rack element and for this purpose, the robot unit comprises a traction device. The traction device may e.g. be a wheel base with at least one wheel being driven by a traction drive unit incorporated in the robot unit. The traction device may alternatively be a crawler device or any other device able to drive the robot unit along the rack element on a corresponding surface incorporated in the rack element or on the floor, upon which the rack element is installed. The rack element may e.g. include a rail arrangement for guiding the robot unit and for interacting with the traction device of the robot unit to effect the tractive movement of the robot unit. The robot unit further comprises a driving device. Said driving device is adapted to couple to said movable carrier device to hereby drive the movable carrier device. This driving of the movable carrier device by the robot unit effects a movement of a carrier supported on the load carrying surface. Thus, the robot unit must not be adapted to carry the weight load of a carrier supported on said movable carrier device. Such carrier is not directly supported on the robot unit. Instead, the robot unit serves to only propel, i.e. to drive, the carrier supported on said movable carrier device. The driving device of the robot unit may e.g. comprise a number of drive rollers or an endless belt drive which are driven into a rotational movement and which may frictionally engage the idle rollers comprised in the rack element and forming the movable carrier device. By this interaction of multiple drive rollers or a belt drive at the robot unit and idle rollers at the rack element, the driving of a carrier supported on said load carrying surface can be accomplished. Alternatively, the robot unit may comprise any other driving device adapted to couple to the load carrier device with a frictional, form-locking engagement or any other type of force or torque transmission.

The robot unit may be adapted to transmit a driving force via said driving device to a carrier supported on said load carrying surface of said movable carrier device and to simultaneously move along said rack element by said traction device. In particular, the robot unit may be designed in such a way as to function from underneath the movable carrier device such that no spatial collision and conflict may occur between the robot unit and a carrier supported on said load carrying surface. The robot unit may thus move along the rack element and simultaneously drives the movable carrier device such that a carrier supported on said load carrying surface moves synchronously with the robot unit along said rack element. The specific preferred design and function of the conveying track, according to this preferred embodiment, is particularly suitable for the selective movement of carriers from the primary storage station to the secondary storage station and vice versa. In particular, the robot unit may convey a carrier on a first way along the rack element from the primary storage unit to the secondary storage unit and deliver this first carrier to the secondary storage unit and hereafter may convey a second carrier to the primary storage unit on the way back. By this, an efficient use of the robot unit and the conveying track is reached. Further, if a faster conveying speed and higher conveying capacity is required between the primary and the secondary storage unit two parallel rack elements, each having a robot unit, may be used such that a simultaneous conveying of carriers back and forth between the primary and the secondary storage unit can be accomplished.

According to a further improved embodiment, said movable carrier device comprises a plurality of rollers each of said rollers being rotatably mounted to said rack element, wherein

said plurality of rollers are arranged side by side to define said movable load carrying surface by an upper part of a circumferential surface of said rollers and to form a coupling surface for coupling to said driving device of said robot unit.

According to this embodiment, a plurality of rollers which preferably are idle rollers are provided to form said movable carrier device. Said rollers thus may serve to carry the load of a carrier and objects positioned on such carrier like e.g. a pallet with objects placed thereon. The pallet is then carried by a number of rollers which are part of said movable carrier device. The pallet can be moved along a roller track formed by said rollers and this movement can be driven by the robot unit. The robot unit may couple by a form-locking or frictional engagement to said rollers forming said roller track. Thus, a top circumferential surface section of said rollers form the load carrying surface and a bottom circumferential surface section of said rollers form a coupling surface to engage a driving device of said robot unit. In such arrangement, the robot unit may be positioned underneath the rollers to drive the rollers and simultaneously may move along the conveying path defined by said rollers. This movement may be synchronous to the movement of a pallet conveyed by the robot unit. In such synchronous conveying action, the traction device may move the robot in one direction, whilst the driving device of the robot may effect a movement of a coupling surface of said driving device in a direction contrary to said moving direction of the traction device. By coupling said coupling surface of the driving device to the idle rollers of the rack element, this backward direction of the movement is inverted to a forward direction at the load carrying surface effecting a movement of the load carrying surface in the same direction as the traction device, i.e., in the same direction as the robot unit.

It is further preferred that said control unit is adapted to control said robot unit such that in a conveying mode said traction device moves said robot unit along said conveying track in said conveying direction with a traction speed and said driving device is driven in opposite direction to said conveying direction with a conveying speed which is twice as high as the traction speed. According to this embodiment, the control unit controls the robot unit in such a way as to effect a synchronous movement of the robot unit and a carrier placed on said load carrying surface along said conveying track. To this extend, the rollers or an endless belt or the like are driven by the driving device. This drive action may preferably be performed from underneath the movable carrier device. By the specific control of the direction of movement of the driving device, being in opposite direction, but twice as high as the traction speed, the conveying speed is superimposed to the traction speed and thus, such synchronous movement is effected.

It is further preferred that said control unit is adapted to control said robot unit such that in an expelling/grabbing mode said traction device is stationary such that said robot unit is stationary at an expelling/grabbing position at said rack element and said driving device is driven with an expelling/grabbing speed.

According to this preferred embodiment, an expelling mode is employed which is understood to be a mode, where a carrier can be moved out of the conveying track by said robot unit. To this extent, the robot unit is kept stationary within said conveying track by controlling a stop of the traction device. Whilst the robot unit is thus kept stationary at the rack element, the driving device of the robot unit is driven to effect a movement of the carrier or object, respectively, which is to be conveyed. The driving device thus effects, via its engagement with the movable carrier device, a movement of the carrier on said load carrying surface and thus, this carrier is conveyed and moves out of its position. Thus, if the position of the carrier was above the robot unit, it is expelled out of this position in this control mode and thus can be moved into a particular position at the primary storage unit or the secondary storage unit.

It is understood that, depending on the direction of movement of the driving device, this mode can be performed as an expelling mode wherein a carrier is moved out of the position above the robot unit or a grabbing mode, wherein a carrier or an object is drawn into a position above the robot unit so to conduct a conveying action hereafter. Thus, the expelling/grabbing mode controlled by said control unit may be used to move a carrier out of the primary or the secondary storage unit to convey such carrier hereafter, or may be used to move a carrier into the primary or secondary storage unit after such conveying of the carrier was performed.

It is understood that the control unit may be adapted to control said robot unit in further modes. E.g., a moving mode could be controlled, wherein said traction device moves said robot unit along said conveying track in said conveying direction with a traction speed and said driving device is driven in opposite direction to said conveying direction with a conveying speed which is identical to said traction speed. In this moving mode, the robot unit is thus moved along the conveying track, but the driving device is moved in opposite direction at the same speed, thus compensating the movement of the traction device and its effect on a carrier supported on said load carrying surface. Thus, the robot unit may be moved through below such carrier with said carrier being kept stationary.

It is further preferred that the expelling/grabbing speed is equal to the traction speed. With this way of control, performed by the control unit, a carrier like a pallet can be drawn out of the primary or secondary storage unit with a grabbing speed and be positioned above the robot unit. After said positioning has been done, the carrier may be conveyed by the robot unit in a conveying mode with the traction device of the robot unit being activated and the driving device of the robot unit being driven with a conveying speed which is twice as high as the traction speed. With these adjustments of the grabbing speed, the traction speed and the conveying speed and further employing a smooth, non-interrupted transition between the expelling/grabbing mode and the conveying mode, the grabbing can be transformed into a conveying of the carrier without the need of any accelerations to be performed in the transition phase between the grabbing and the conveying. In the same way, the expelling speed shall be kept equal to the traction speed such that the expelling of a carrier at the end of a conveying step can be performed without any acceleration or deceleration of a carrier.

It is further preferred that the conveyor sorting device is configured such that m<n and wherein said control unit is adapted to identify m+n different categories. According to this embodiment, a significant number of m+n categories can be controlled by said control unit and thus, a sorting procedure of such significant number of different categories can be accomplished by the conveyor sorting device according to the invention.

It is further preferred that the sorting device comprises a cross traverse rack element adapted to take up said robot unit, wherein said cross traverse rack element comprises a traverse movable load carrying device having an upper traverse load surface adapted to take up an object and a traverse coupling interface, wherein said cross traverse rack element is adapted to move in a lateral direction with respect to a conveying direction from said primary storage unit to said secondary storage unit and vice versa, wherein said cross traverse rack element is further adapted to couple to any of said primary storage positions and to transfer an object positioned on said traverse load surface to any of said primary storage positions, wherein by said lateral movement said cross traverse rack element moves along a number of m positions, each of said m positions corresponding to a position where said cross traverse rack element is positioned to transfer an object to one of said m primary storage positions.

The cross traverse rack element may be different from the rack elements forming the conveyor track between the primary and secondary storage unit. The cross traverse rack element serves to connect the said conveyor track and the primary storage positions and for this purpose is configured to perform a movement in the lateral direction with respect to the conveying direction along the first or the second conveyor track. The robot unit may connect, or may be positioned at the cross traverse rack element such that a synchronous movement of the cross traverse rack element and the robot unit takes place. This can e.g. be achieved in that the cross traverse rack element comprises traction surfaces like rails which can be engaged by the traction device of the robot unit.

The cross traverse rack element further comprises a traverse movable load carrying device. This traverse movable load carrying device may be somewhat similar or even identical to the movable load carrying device of the rack elements. In this configuration, a rack element may form a primary storage position to allow efficient conveying of the carriers into and out of the primary storage positions by the robot unit. The traverse movable load carrying device comprises a traverse load surface and a traverse coupling interface which may be close to similar or even identical with the load surface and the coupling interface of the rack elements. By this, an object or carrier can be supported by the cross traverse rack element and can be conveyed by corresponding interaction with a robot unit driving said traverse movable load carrying device with its driving device via the traverse coupling interface. Generally, the robot unit and an object or carrier may be moved in a lateral direction together and simultaneously by the cross traverse rack element performing such lateral movement. By this, both the robot unit and an object or carrier can be transported from one primary storage position to an other primary storage position and to the conveyor track connecting the primary storage unit with the secondary storage unit.

The cross traverse rack element is adapted to couple to any of the primary storage positions or the conveyor track such that the robot unit may release the connection hereafter or leave the cross traverse rack element and may move to the primary storage position or to the conveyor track, respectively. Further, this coupling may allow to convey an object or carrier from the cross traverse rack element to a primary storage position or the conveyor track, respectively. Thus, generally, it is possible to convey an object or carrier along the conveyor track by the robot unit, position this object or carrier at the cross traverse rack element simultaneously with the robot unit and then expel or gather the object or carrier by the robot unit to a primary storage position. This option opens a highly variable and fast exchange of carriers between the primary and the secondary storage unit with a significant capacity at low investment costs.

It is understood that alternatively or additionally a secondary cross traverse rack element may be provided at the secondary storage unit to distribute, expel and gather carriers to and from any secondary storage position, where the functionality may correspond to the distributing, expelling and gathering of carriers to and from the primary storage positions explained beforehand.

According to a further preferred embodiment said cross traverse rack element comprises a traverse traction device with a traverse traction coupling interface adapted to couple to said traction device or said driving device of said robot unit when said robot unit taken up by said cross traverse rack element such that a driving force transmitted via said traverse traction coupling interface from said robot unit to said traverse traction device drives the lateral movement of the cross traverse rack element with said robot unit taken up. According to this embodiment, a traverse traction device is provided at the cross traverse rack element. This traverse traction device allows to be coupled to either the traction device or the driving device of the robot unit. By this, a force or torque can be transmitted from said traction device or driving device to the traverse traction device to effect the movement of the cross traverse rack element in the traverse direction. By this, the movement of the cross traverse rack element is driven by the robot unit, in particular, by the drives installed in the robot unit to drive the traction device or the driving device. The traverse traction coupling interface could be adapted to be releasable to allow a movement of the robot unit in relation to the cross traverse rack element in a released state and to allow the robot unit to be stationary within the cross traverse rack element and to drive the traverse movement in a coupled state of said traverse traction coupling interface. It is understood that as a general alternative to this embodiment, the cross traverse rack element may comprise a drive to directly drive said traverse traction device and to hereby provide an autonomous movement of the traverse traction device with or without the robot unit.

According to a further preferred embodiment, wherein said traverse coupling interface is adapted to couple to said driving device of said robot unit and wherein a force transferred via said traverse coupling interface from said driving device to said traverse movable carrier device conveys an object positioned on said traverse load carrying surface. According to this embodiment, the traverse coupling interface allows driving of the traverse movable carrier device by the driving device of the robot unit. This coupling between the driving device and the traverse movable carrier device may be designed and accomplished in a similar or identical way as the coupling of the driving device to the coupling interface of the movable carrier device in one of said conveyor tracks. By this coupling, an object or a carrier can be conveyed to or from said cross traverse rack element.

In particular, the cross traverse rack element may be integrated into a conveyor track formed from rack elements and objects or carriers may be conveyed along said conveyor track including said cross traverse rack element at an end position or in an intermediate position in said conveyor track extending between the primary and the secondary storage unit.

A further aspect of the invention is a method for sorting objects in a conveyor sorting device, comprising the steps of:
receiving objects of different object categories at an input port,
transferring said object to a primary storage unit by a sorting device with a handling unit,
wherein said primary storage unit comprises a plurality of n primary storage positions each of said primary storage positions being associated to a carrier for one specific object category,
receiving information identifying an input category of an input object transferred to the sorting device via the input port in a control unit,
comparing said input category with the said categories associated with said primary storage positions in said control unit,
   if any of said primary storage positions is associated to said input category:
      controlling said handling unit for receiving said input object and to transfer said input object to a primary storage position associated to said input category,
   if none of said primary storage positions is associated to said input category
      to control said conveyor device to convey one of said carriers from one of said primary storage positions along to a secondary storage unit,
      wherein said secondary storage unit comprises a plurality of m secondary storage positions each of said secondary storage positions being associated to a carrier for one specific object category,
      controlling said secondary storage unit to provide a carrier stored in said secondary storage unit and associated with said input category to said conveyor device,
      controlling said conveyor device to convey said carrier provided by said secondary storage unit to said one of said primary storage positions wherefrom a carrier had been transferred to said secondary storage unit, and
      controlling said handling unit for receiving said input object and to transfer said input object to the primary storage position comprising said carrier which had been transferred from said secondary storage unit and which is associated to said input category.

Said method may be improved according to a first aspect, wherein
said carrier is conveyed along a first conveying track from said primary storage unit to said secondary storage unit and wherein said carrier is conveyed along a second conveying track for conveying a carrier from said second storage unit to said first storage unit, or
wherein said carrier is conveyed along a single conveying track from said primary storage unit to said secondary storage unit and vice versa.

Said improvement according to said first aspect may be further improved according to a second aspect, wherein said carrier is conveyed on top of a movable load carrying surface of a movable carrier device along said conveying track comprises

a. and said conveying along said conveyor track is effected by a robot unit comprising a traction device, wherein said robot unit is driven along said rack element in said conveying direction by said traction device and wherein said robot unit further comprises a driving device, wherein said driving device couples with said movable carrier device and drives said movable carrier device, wherein said coupling of said driving device to said movable carrier device enables said driving device to move said carrier on top of said movable load carrying surface.

Said improvement according to said second aspect may be further improved according to a third aspect, wherein said movable carrier device comprises a plurality of rollers each of said rollers being rotatably mounted to said rack element, wherein said plurality of rollers are arranged side by side to define said movable load carrying surface by an upper part of a circumferential surface of said rollers, wherein said driving device couples to a coupling surface formed by a lower part of a circumferential surface of said rollers.

Said improvement according to said third aspect may be further improved according to a fourth aspect, wherein

a) in a conveying mode said control unit controls said robot unit such that said traction device moves said robot unit along said conveying track in said conveying direction with a traction speed and said driving device is driven in opposite direction to said conveying direction with a conveying speed which is twice as high as the traction speed and/or

b) in an expelling/grabbing mode said control unit controls said robot unit such that said traction device is stationary such that said robot unit device is stationary at an expelling/grabbing position at said rack element and said driving device is driven with an expelling/grabbing speed

wherein preferably said expelling/grabbing speed is equal to said traction speed.

Said improvement according to said first aspect may be further improved according to a fifth aspect, wherein said conveyor device comprises a cross traverse rack element adapted to take up said robot unit,
wherein said cross traverse rack element comprises a traverse movable load carrying device having an upper traverse load surface adapted to take up an object and a traverse coupling interface,
wherein said cross traverse rack element moves in a lateral direction with respect to a conveying direction from said primary storage unit to said secondary storage unit and vice versa,
wherein said cross traverse rack element couples to any of said primary storage positions and transfers an object positioned on said traverse load surface to said any of said primary storage positions,
wherein said cross traverse rack element moves laterally along a number of m positions, each of said m positions corresponding to a position where said cross traverse rack element is positioned to transfer an object to one of said m primary storage positions.

Said improvement according to said fifth aspect may be further improved according to a sixth aspect, wherein said cross traverse rack element comprises a traverse traction device with a traverse traction coupling interface coupling to said traction device or said driving device of said robot unit when said robot unit taken up by said cross traverse rack element, wherein a driving force is transmitted via said traverse traction coupling interface from said robot unit to said traverse traction device said driving force driving the cross traverse rack element laterally with said robot unit taken up.

Said improvement according to said fifth or sixth aspect may be further improved according to a seventh aspect, wherein said traverse coupling interface couples to said driving device of said robot unit and wherein a force is transferred via said traverse coupling interface from said driving device to said traverse movable carrier device and said force conveys an object positioned on said traverse load carrying surface.

### BRIEF DESCRIPTION OF THE DRAWINGS

Preferred embodiments of the invention are explained with reference to the figures.

FIG. 1 shows a schematic perspective view of a sorting device according to a preferred embodiment of the invention.

FIG. 2 shows a perspective cutout view of a part of the sorting device with a traverse rack element.

### DETAILED DESCRIPTION OF THE PREFERRED EMBODIMENTS

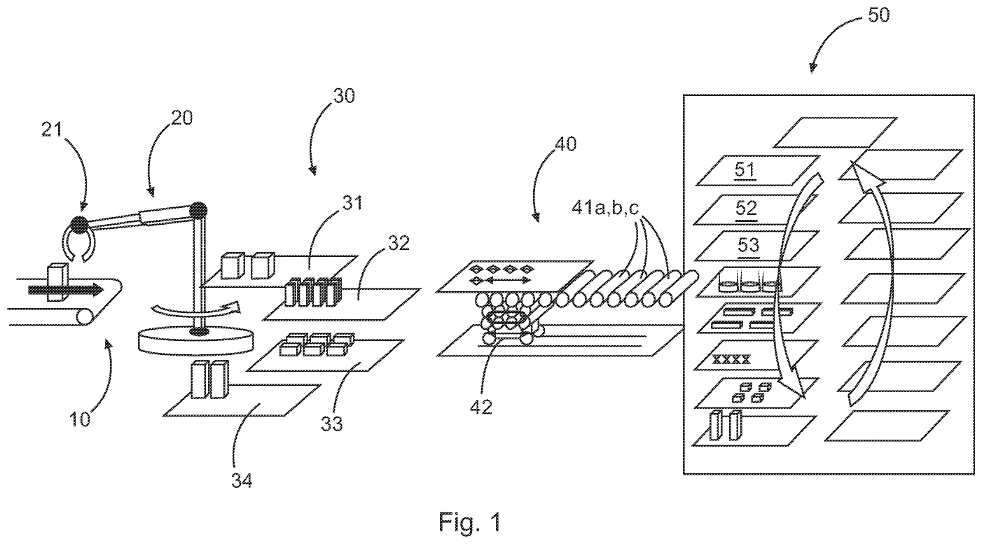

As can be seen in FIG. 1, the sorting of objects by the sorting device starts with an object being delivered to the sorting device via an input port 10 on the left side of the sorting device, shown in the figure. The input port 10 may be a virtual position, where objects are conveyed or delivered or wherein objects are positioned in any other manner. In the embodiment shown in the figure, a belt drive conveys an object to the input port.

A multi-axes robot unit 20 is provided to pick up objects delivered via the input part and to sort these objects to one of in a primary storage 30 having one of more, in particular four primary storage positions 31, 32, 33, 34. The robot unit 20 comprises a gripping unit 21 to grip, hold and release objects delivered via the input port and a handling unit comprising rotating joints and telescopic legs to position the object in one of the primary storage positions. The primary storage positions 31-34 are formed by a pallet placed in the respective primary storage position. The four primary storage positions form the primary storage unit. It is understood that less or more than four primary storage positions may be present in such primary storage unit according to the invention.

As can be seen, different objects are placed in the primary storage unit, wherein each pallet in a single primary storage position carries objects of one single category only. Thus, four specific categories can be directly sorted by the sorting device 20 to a position in the primary storage unit.

The pallets placed in the primary storage positions can be transferred via a conveying track 40 to a secondary storage unit 50. The conveying track 40 serves for a moving of pallets out of the primary storage unit to the secondary storage unit and vice versa. To this extent, the conveying track comprises a plurality of idle rollers 41a, b, c, upon which a pallet can be moved in a rolling condition of the idle rollers 41a, b, c, . . . . The idle rollers 41a, b, c are adapted for a rotating movement, but are not equipped with an integral drive for rotating the idle rollers. A robot unit 42 is positioned underneath the idle rollers 41a, b, c. The robot 42 comprises a driving device with a friction chain or belt adapted to frictionally engage the idle rollers 41a, b, c from underneath. The driven rollers of the robot unit 42 are arranged for a crawling movement such that the driven rollers and the robot unit can horizontally move along the idle rollers 41a, b, c with and maintain the frictional engagement of the driven rollers to the idle rollers 41a, b, c. The robot 42 further comprises four wheels contacting the ground surface including two traction wheels and being driven for moving the robot unit 42 along the conveying direction of the conveying track formed by the robot unit and the idle rollers 41a, b, c. The robot unit 42 thus may move forward and backward along the conveying direction defined by the conveying track and thus may convey pallets from the primary storage unit to the secondary storage unit and vice versa. Further, the robot unit 42 may be kept stationary at one end of the conveying track to grab a pallet out of the primary or the secondary storage unit by driving the driven rollers only and keeping the traction wheels stationary. This stationary driving of the driven rollers may further be used to expel a pallet into the primary storage unit or the secondary storage unit.

The secondary storage unit 50 comprises a plurality of pallet positions 51, 52, 53, . . . which are occupied by a corresponding number of pallets. The pallet positions are arranged in a carousel-like arrangement and the secondary storage unit may move the secondary storage positions by a rotating upward/downward movement to position a distinct secondary storage position with a specific pallet at an expelling/grabbing position to allow the robot unit 42 to grab that specific pallet out of the secondary storage unit.

The four pallets positioned in the primary storage unit 30 are envisaged to store objects of four specific categories, wherein these four categories are those which are currently mainly delivered via the input board into the sorting device. As long as only objects of any of these categories are delivered via the input board, the conveying track needs not to transport any pallets back or forth between the primary and the secondary storage unit. Rather, the sorting device may place such objects of any of these four categories directly onto the corresponding pallet associated with said category.

As soon as an object is delivered to the sorting device which does not belong to any of the four categories associated with the pallets based in the four primary storage positions, the robot unit 42 will pull out one of the pallets out of a primary storage position 31-34 and convey this pallet into a free pallet position 51, 52, 53, . . . in the secondary storage unit 50. This conveying action will move the robot unit 42 from the left position close to the primary storage unit 30 to the right position at the secondary storage unit 50 in a synchronous movement with the pallet to be transported. After the pallet has been positioned in the pallet position 51, 52, 53, . . . , the carousel of the secondary storage unit 50 will move and will position the specific pallet for carrying objects associated with the category of the particular object delivered to the input port 10 at a grabbing position wherein the robot unit 42 may grab the pallet out of the secondary storage unit 50. The robot unit 42 then moves back to the left, synchronously with that particular pallet grabbed out of the secondary storage unit 50. The pallet is expelled by the robot unit 40 to a free storage position 31-34 of the primary storage 30, which was occupied by the pallet delivered to the secondary storage unit 50 beforehand. The sorting device may then sort the object of the respective category on this pallet. This process may be repeated as soon as a further object of a sixth category is delivered to the sorting device via the input port.

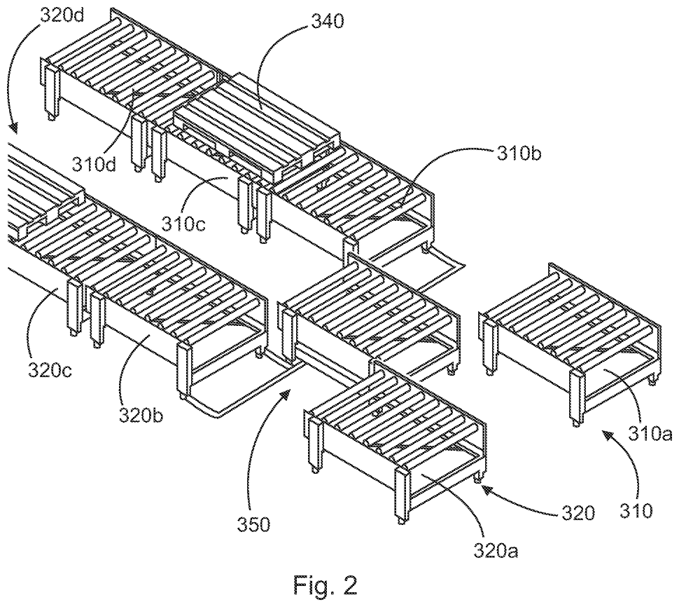

FIG. 2 shows a schematic setup of a conveyor device. The conveyor device comprises a first conveying track 310 and a second conveying track 320. The conveying tracks 310, 320 are arranged in a parallel arrangement to each other such that pallets 340 may be conveyed in a first conveying direction on the first conveyor track 310 and a second conveying direction which is parallel, but in a lateral distance to the first conveying direction on the second conveyor track.

The two conveyor tracks thus are in a lateral distance to each other. Each conveyor track is composed of a plurality of rack elements 310b-d and 320b-d. The first conveyor track may serve to transport a pallet from a first storage unit to a second storage unit and the second conveyor track may serve to transport a pallet from the second storage unit to the first storage unit. Alternatively, a single conveyor track for transporting pallets in both directions may be present. Further, rack elements 310a and 320b are present which may be understood to each represent a primary storage position or to each represent a secondary storage position. It is understood, that in lateral distance to the rack elements, i.e. in the direction perpendicular to the conveying direction along the conveyor tracks, further rack elements may be positioned which constitute further primary or secondary storage positions. It is further understood, that the secondary or primary storage unit is positioned at the opposed, left end of the conveyor track and is not depicted in FIG. 2. This storage unit at the other end may be configured by a plurality of single rack elements in lateral distance to each other, like the rack elements 310a, 320a.

Each conveyor track 310, 320 comprises a movable carrier device formed by a plurality of idle rollers and being capable of carrying a pallet and allowing such pallet to move in the conveying direction along the conveyor tracks. Underneath this movable carrier device formed by the idle rollers, a free space is present below the idle rollers. In this free space, a robot unit can move along the conveyor track and hereby drive the idle rollers with a driving device. By this, the pallet can be conveyed by the driving force transmitted by such robot unit along the conveyor track.

A cross traverse rack module 350 is arranged for transferring objects like a pallet from the first conveyor track to the second conveyor track and vice versa. The cross traverse rack element comprises a traction device which is adapted to move said cross traverse rack element in a traverse direction with respect to the conveying direction.

A gap is present between the rack elements 310a and 310b and between the rack elements 320a and 320b. This gap is dimensioned such that the cross traverse rack element 350 fits into this gap and fills this gap. If the cross traverse rack element is positioned in any such gap, the movable carrier device formed by the rack elements and the cross traverse rack element defines an upper continuous load carrying surface allowing an object like a pallet 340 to move over the whole length of the conveyor track.

The cross traverse rack element, to this extent, comprises a movable carrier device similar to those of the rack elements. Further, a space below this movable carrier device is present at the cross traverse rack element adapted for taking up a robot unit. The cross traverse rack element may transfer such robot unit simultaneously with a pallet or independently from such pallet from the gap in the first conveyor track to the gap in the second conveyor track and vice versa. By this, pallet and robot unit can be transferred between the two conveyor tracks. The cross traverse rack element may comprise a drive unit to drive the lateral movement between the two gaps of the conveyor tracks or may comprise a coupling interface adapted to couple to the traction device or the driving device of the robot unit such that the traction device or the driving device, respectively, may drive the traverse movement of the cross traverse rack element.

The cross traverse rack element may thus couple to any of the rack elements 310a, 320a or further rack elements constituting primary or secondary storage positions. A carrier like a pallet may be drawn from such rack element onto the cross traverse rack element or expelled to such rack element from the cross traverse rack element. The cross traverse rack element may convey a carrier like a pallet along the conveyor tracks to transport said carrier to the primary or secondary storage unit at the other end of the conveyor track, respectively.

### LIST OF REFERENCE NUMERALS

10 input port

20 robot unit

21 gripping unit

30 primary storage

31, 32, 33, 34 storage position

40 conveying track

41a,b,c idle roller

42 robot unit

50 secondary storage unit

51, 52, 53 . . . pallet position

310 first conveying track

310a-d first rack element

320 second conveying track

320a-c second rack element

340 pallet

350 cross traverse rack module

1. A conveyor sorting device, comprising:
an input port (10) for receiving objects of different object categories,
a sorting device (20) with a handling unit comprising a holding device (21) for receiving and holding an object input via the input port (10) and a transfer device for transferring said object to a primary storage unit (30),
characterized in that
said primary storage unit (30) comprises a plurality of n primary storage positions (31, 32, 33, 34) each of said primary storage positions (31, 32, 33, 34) being associated to a carrier (340) for one specific object category,
a secondary storage unit (50) comprising a plurality of m secondary storage positions each of said secondary storage positions being associated to a carrier (340) for one specific object category,
a conveyor device adapted to convey a carrier (340) from said primary storage unit (30) (30) to said secondary storage unit (50) and to convey a carrier (340) from said secondary storage unit (50) to said primary storage unit (30),
a control unit adapted
to receive information identifying an input category of an input object transferred to the sorting device (20) via the input port (10),
to compare said input category with the said categories associated with said primary storage positions (31, 32, 33, 34),
if any of said primary storage positions (31, 32, 33, 34) is associated to said input category:
to control said handling unit for receiving said input object and to transfer said input object to a primary storage position associated to said input category,
if none of said primary storage positions (31, 32, 33, 34) is associated to said input category
to control said conveyor device to convey one of said carriers (340) from one of said primary storage positions (31, 32, 33, 34) to said secondary storage unit (50),
to control said secondary storage unit (50) to provide a carrier (340) stored in said secondary storage unit (50) and associated with said input category to said conveyor device,
to control said conveyor device to convey said carrier (340) provided by said secondary storage unit (50) to said one of said primary storage positions (31, 32, 33, 34) wherefrom a carrier (340) had been transferred to said secondary storage unit (50), and
to control said handling unit for receiving said input object and to transfer said input object to the primary storage position comprising said carrier (340) which had been transferred from said secondary storage unit (50) and which is associated to said input category.

2. The conveyor sorting device according to claim 1, characterized in that said conveyor device comprises a first conveying track (310, 40) for conveying a carrier (340) from said primary storage unit (30) to said secondary storage unit (50) and a second conveying track (320, 40) for conveying a carrier (340) from said second storage unit to said first storage unit.

3. The conveyor sorting device according to claim 1, characterized in that said conveyor device comprises a single conveying track (40) for conveying a carrier (340) from said primary storage unit (30) to said secondary storage unit (50) and vice versa.

4. The conveyor sorting device according to claim 2, characterized in that each of said conveying track (310, 320, 40) comprises
a. a rack element (310a-d, 320a-d) extending along a conveying direction, said rack element (310a-d, 320a-d) comprising a movable load carrying surface defined by a movable carrier (340) device,
b. a robot unit (42) comprising a traction device for driving said robot unit (42) along said rack element (310a-d, 320a-d) in said conveying direction and a driving device adapted to couple with said movable carrier device and to drive said movable carrier device, wherein said coupling of said driving device to said movable carrier device enables said driving device to move said movable load carrying surface.

5. The conveyor sorting device according to claim 4, characterized in that said movable carrier device comprises a plurality of rollers (41a, b, c, . . . ) each of said rollers (41a, b, c, . . . ) being rotatably mounted to said rack element (310a-d, 320a-d), wherein said plurality of rollers (41a, b, c, . . . ) are arranged side by side to define said movable load carrying surface by an upper part of a circumferential surface of said rollers (41a, b, c, . . . ) and to form a coupling surface for coupling to said driving device of said robot unit (42).

6. The conveyor sorting device according to claim 5, characterized in that said control unit is adapted to control said robot unit (42) such that
c. in a conveying mode said traction device moves said robot unit (42) along said conveying track (40) in said conveying direction with a traction speed and said driving device is driven in opposite direction to said conveying direction with a conveying speed which is twice as high as the traction speed.

7. The conveyor sorting device according to claim 5, characterized in that said control unit is adapted to control said robot unit (42) such that
d. in an expelling/grabbing mode said traction device is stationary such that said robot unit (42) device is stationary at an expelling/grabbing position at said rack element (310a-d, 320a-d) and said driving device is driven with an expelling/grabbing speed.

8. The conveyor sorting device according to claims 6, characterized in that said expelling/grabbing speed is equal to said traction speed.

9. The conveyor sorting device according to claim 1, characterized in that n>m and wherein said control unit is adapted to identify m+n different categories.

10. The conveyor sorting device according to claim 4, characterized by a cross traverse rack element (350) adapted to take up said robot unit (42),
wherein said cross traverse rack element (350) comprises a traverse movable load carrying device having an upper traverse load surface adapted to take up an object and a traverse coupling interface,
wherein said cross traverse rack element (350) is adapted to move in a lateral direction with respect to a conveying direction from said primary storage unit (30) to said secondary storage unit (50) and vice versa,
wherein said cross traverse rack element (350) is further adapted to couple to any of said primary storage positions (31, 32, 33, 34) and to transfer an object positioned on said traverse load surface to any of said primary storage positions (31, 32, 33, 34),
wherein by said lateral movement said cross traverse rack element (350) moves along a number of m positions, each of said m positions corresponding to a position where said cross traverse rack element (350) is positioned to transfer an object to one of said m primary storage positions (31, 32, 33, 34).

11. The conveyor sorting device according to claim 10,
characterized in that said cross traverse rack element (350) comprises a traverse traction device with a traverse traction coupling interface adapted to couple to said traction device or said driving device of said robot unit (42) when said robot unit (42) taken up by said cross traverse rack element (350) such that a driving force transmitted via said traverse traction coupling interface from said robot unit (42) to said traverse traction device drives the lateral movement of the cross traverse rack element (350) with said robot unit (42) taken up.

12. The conveyor sorting device according to claim 10,
characterized in that said traverse coupling interface is adapted to couple to said driving device of said robot unit (42) and wherein a force transferred via said traverse coupling interface from said driving device to said traverse movable carrier device conveys an object positioned on said traverse load carrying surface.

13. A method for sorting objects in a conveyor sorting device, characterized by the steps of:
receiving objects of different object categories at an input port (10),
transferring said object to a primary storage unit (30) by a sorting device (20) with a handling unit,
wherein said primary storage unit (30) comprises a plurality of n primary storage positions (31, 32, 33, 34) each of said primary storage positions (31, 32, 33, 34) being associated to a carrier (340) for one specific object category,
receiving information identifying an input category of an input object transferred to the sorting device (20) via the input port (10) in a control unit,
comparing said input category with the said categories associated with said primary storage positions (31, 32, 33, 34) in said control unit,
f any of said primary storage positions (31, 32, 33, 34) is associated to said input category:
controlling said handling unit for receiving said input object and to transfer said input object to a primary storage position (31, 32, 33, 34) associated to said input category,
if none of said primary storage positions (31, 32, 33, 34) is associated to said input category
to control said conveyor device to convey one of said carriers (340) from one of said primary storage positions (31, 32, 33, 34) along to a secondary storage unit (50),
wherein said secondary storage unit (50) comprises a plurality of m secondary storage positions each of said secondary storage positions being associated to a carrier (340) for one specific object category,
controlling said secondary storage unit (50) to provide a carrier stored in said secondary storage unit (50) and associated with said input category to said conveyor device,
controlling said conveyor device to convey said carrier (340) provided by said secondary storage unit (50) to said one of said primary storage positions (31, 32, 33, 34) wherefrom a carrier (340) had been transferred to said secondary storage unit (50), and
controlling said handling unit for receiving said input object and to transfer said input object to the primary storage position comprising said carrier which had been transferred from said secondary storage unit (50) and which is associated to said input category.

14. The method according to claim 13, characterized in that
said carrier (340) is conveyed along a first conveying track (310, 40) from said primary storage unit (30) to said secondary storage unit (50) and wherein said carrier (340) is conveyed along a second conveying track (320, 40) for conveying a carrier (340) from said second storage unit to said first storage unit, or
wherein said carrier (340) is conveyed along a single conveying track (40) from said primary storage unit (30) to said secondary storage unit (50) and vice versa,
wherein preferably said carrier (340) is conveyed on top of a movable load carrying surface of a movable carrier device along said conveying track (40) comprises
a. And said conveying along said conveyor track is effected by a robot unit (42) comprising a traction device, wherein said robot unit (42) is driven along said rack element in said conveying direction by said traction device and wherein said robot unit (42) further comprises a driving device, wherein said driving device couples with said movable carrier device and drives said movable carrier device, wherein said coupling of said driving device to said movable carrier device enables said driving device to move said carrier on top of said movable load carrying surface,
wherein further preferably
b. in a conveying mode said control unit controls said robot unit (42) such that said traction device moves said robot unit (42) along said conveying track (40) in said conveying direction with a traction speed and said driving device is driven in opposite direction to said conveying direction with a conveying speed which is twice as high as the traction speed and/or
c. in an expelling/grabbing mode said control unit controls said robot unit (42) such that said traction device is stationary such that said robot unit device (42) is stationary at an expelling/grabbing position at said rack element and said driving device is driven with an expelling/grabbing speed wherein preferably said expelling/grabbing speed is equal to said traction speed.

15. The method according to claim 13, characterized in that said conveyor device comprises a cross traverse rack element (350) adapted to take up said robot unit (42),
wherein said cross traverse rack element (350) comprises a traverse movable load carrying device having an upper traverse load surface adapted to take up an object and a traverse coupling interface,
wherein said cross traverse rack element (350) moves in a lateral direction with respect to a conveying direction from said primary storage unit (30) to said secondary storage unit (50) and vice versa,
wherein said cross traverse rack element (350) couples to any of said primary storage positions (31, 32, 33, 34) and transfers an object positioned on said traverse load surface to said any of said primary storage positions (31, 32, 33, 34),
wherein said cross traverse rack element (350) moves laterally along a number of m positions, each of said m positions corresponding to a position where said cross traverse rack element (350) is positioned to transfer an object to one of said m primary storage positions (31, 32, 33, 34),
wherein further preferably said cross traverse rack element (350) comprises a traverse traction device with a traverse traction coupling interface coupling to said traction device or said driving device of said robot unit (42) when said robot unit (42) taken up by said cross traverse rack element (350), wherein a driving force is transmitted via said traverse traction coupling interface from said robot unit (42) to said traverse traction device said driving force driving the cross traverse rack element (350) laterally with said robot unit (42) taken up, and or,
wherein preferably said traverse coupling interface couples to said driving device of said robot unit (42) and wherein a force is transferred via said traverse coupling interface from said driving device to said traverse movable carrier device and said force conveys an object positioned on said traverse load carrying surface.
